(19) United States
(12) Patent Application Publication
(10) Pub. No.: US 2009/0038319 A1
(43) Pub. Date: Feb. 12, 2009

(54) Cryopanel and Cryopump Using the Cryopanel

(75) Inventor: Ryosuke Tsuyuki, Tokyo (JP)

Correspondence Address: IPUSA, P.L.L.C, 1054 31ST STREET, N.W., Suite 400, Washington, DC, 20007, US

(73) Assignee: SUMITOMO HEAVY INDUSTRIES, LTD.

(21) Appl. No.: 12/166,488

(22) Filed: Jul. 2, 2008

(30) Foreign Application Priority Data
Aug. 8, 2007 (JP) 2007-206907
Feb. 8, 2008 (JP) 2008-029048

(51) Int. Cl. F04B 37/08; B01D 8/00

(52) U.S. Cl. 62/55.5

(57) ABSTRACT

A cryopanel used for a cryopump, the cryopump including a vacuum chamber having a gas flow-in opening; a stage provided in the vacuum chamber; and a cryocooler configured to cool the stage, the cryopump being configured to solidify or absorb a molecule flowing from the gas flow-in opening into the vacuum chamber, the cryopanel includes a first panel held and cooled by the stage, the first panel having a surface facing toward the gas flow-in opening; and a second panel held by the first panel and extending from the first panel in an upstream direction of a gas flow-in, the second panel having a surface where an absorption material layer is formed.

### BACKGROUND OF THE INVENTION

1. Field of the Invention

The present invention generally relates to cryopanels and cryopumps using the cryopanels.

2. Description of the Related Art

In semiconductor manufacturing apparatuses, cryopumps have been used for realizing high vacuum states. The cryopump realizes the high vacuum state by cooling a cryopanel situated in a vacuum chamber and solidifying or absorbing molecules.

It is normal practice that the cryopanel is connected to a stage of a cryocooler. The cryopanel includes a disk-shaped panel and plural plate-shaped panels. The front surface of the disk-shaped panel is provided horizontally and facing in an upstream direction in a gas flow-in. Plural plate-shape panels are provided on the rear surface side of the disk-shaped panel and extend in a direction downstream in the gas flow-in.

Gas in a process chamber flows in from an upper part opening of the vacuum chamber. Hydro-molecules are solidified mainly by louvers provided above the cryopanel. Argon or nitrogen other than the hydro-molecules is solidified mainly by the disk-shaped panel. Hydrogen, helium, or the like which is not frozen at cryogenic temperatures is absorbed by absorption layers formed on both surfaces of the plate-shape panels. See, for example, Japanese Laid-Open Patent Application Publication No. 2-308985.

In addition, a cryopump having the following structure has been also suggested in order to improve absorption properties. In this cryopump, black chromium plating is applied to an inner surface of a shield configured to protect the cryopanel from radiation heat and a surface facing downward of louvers provided above the shield. See, for example, Japanese Laid-Open Patent Application Publication No. 5-172054.

In the meantime, in order to improve hydrogen discharge velocity that is a main property of the cryopump, it is necessary to improve the probability that the hydrogen molecules will be absorbed by the absorption layer.

However, in the cryopanel discussed in Japanese Laid-Open Patent Application Publication No. 2-308985, the plate-shaped panels where the absorption layers are formed are provided only on the rear surface side of the disk-shaped panel, namely a downstream side in the gas flow-in direction of the disk-shaped panel. In addition, the portion of the area in the vacuum chamber occupied by the disk-shaped panel occupied is large.

Therefore, under this structure, the discharge velocity is limited. Furthermore, solidifying and absorption efficiencies of the plate-shaped panels are low behind the disk-shaped panel, namely downstream at the rear side of the disk-shaped panel.

Furthermore, in the cryopump discussed in Japanese Laid-Open Patent Application Publication No. 5-172054, the structure of the cryopanel itself is the same as that of the cryopanel discussed in Japanese Laid-Open Patent Application Publication No. 2-308985, In addition, the plate shaped panels where the absorption layers are formed are provided at only the rear surface side of the disk-shaped panel, in the downstream direction in the gas flow-in.

Therefore, under this structure, the discharge velocity is limited. Furthermore, solidifying and absorption efficiencies of the plate-shaped panels are low behind the disk-shaped panel, namely downstream at the rear side of the disk-shaped panel.

### SUMMARY OF THE INVENTION

Accordingly, embodiments of the present invention may provide a novel and useful cryopanel and cryopump using the cryopanel solving one or more of the problems discussed above.

More specifically, the embodiments of the present invention may provide a cryopanel whereby discharge velocity and solidifying and absorption efficiencies are improved and may also provide a cryopump using the cryopanel.

One aspect of the embodiment of the present invention may be to provide a cryopanel used for a cryopump,

the cryopump including
a vacuum chamber having a gas flow-in opening;
a stage provided in the vacuum chamber; and
a cryocooler configured to cool the stage,

the cryopump being configured to solidify or absorb a molecule flowing from the gas flow-in opening into the vacuum chamber,

the cryopanel comprising:

a first panel held and cooled by the stage, the first panel having a surface facing toward the gas flow-in opening; and

a second panel held by the first panel and extending from the first panel in an upstream direction of a gas flow-in, the second panel having a surface where an absorption material layer is formed.

Another aspect of the embodiment of the present invention may be to provide a cryopump, comprising:

a vacuum chamber having a gas flow-in opening;

a cryocooler having a stage provided in the vacuum chamber, the cryocooler being configured to cool the stage

a cryopanel;

a shield having an opening part connected to the cryocooler so that the opening part faces the gas flow-in opening of the vacuum chamber, the shield having an inside where the cryopanel is received, the shield being configured to protect the cryopanel from radiation heat of the vacuum chamber; and

a louver covering the opening of the shield;

wherein a molecule flowing from the gas flow-in opening to the vacuum chamber is solidified or absorbed by the cryopump;

the cryopanel includes
a first panel held and cooled by the stage, the first panel having a surface facing toward the gas flow-in opening, and
a second panel held by the first panel and extending from the first panel in an upstream direction of a gas flow-in, the second panel having a surface where an absorption material layer is formed; and

blackening is applied to a surface of the louver which surfaces is in a downstream direction of the gas flow-in.

According to the embodiments of the present invention, it is possible to provide a cryopanel whereby discharge velocity and solidifying and absorption efficiencies are improved and to also provide a cryopump using the cryopanel.

Other objects, features, and advantages of the present invention will become more apparent from the following detailed description when read in conjunction with the accompanying drawings.

### BRIEF DESCRIPTION OF THE DRAWINGS

FIG. 1 is a structural view of a cryopump where a cryopanel of an embodiment of the present invention is used;

FIG. 2 is a view showing a structure of the cryopanel of the embodiment of the present invention (FIG. 2(a) is a front view and FIG. 2(b) is a plan view);

FIG. 3 is a view of a cryopanel of a first modified example of the embodiment of the present invention (FIG. 3(a) if a front view and FIG. 3(b) is a plan view);

FIG. 4 is a view of a cryopanel of a second modified example of the embodiment of the present invention (FIG. 4(a) is a front view and FIG. 4(b) is a plan view);

FIG. 5 is a view of a cryopanel of a third modified example of the embodiment of the present invention (FIG. 5(a) is a front view and FIG. 5(b) is a plan view);

FIG. 6 is a view of a cryopanel of a fourth modified example of the embodiment of the present invention (FIG. 6(a) is a front view and FIG. 6(b) is a plan view);

FIG. 7 is a view of a cryopanel of a fifth modified example of the embodiment of the present invention (FIG. 7(a) is a front view and FIG. 7(b) is a plan view);

FIG. 8 is a view of a cryopanel of a sixth modified example of the embodiment of the present invention (FIG. 8(a) is a front view and FIG. 8(b) is a plan view);

FIG. 9 is a front view of a modified example of a plate-shaped panel included in the cryopanel of the embodiment of the present invention;

FIG. 10 is a plan view of a cryopump of a seventh modified example of the embodiment of the present invention;

FIG. 11 is a perspective view of the cryopump of the seventh modified example of the embodiment of the present invention; and

FIG. 12 is a graph showing cooling properties of the cryopump of the seventh modified example of the embodiment of the present invention.

### DETAILED DESCRIPTION OF THE PREFERRED EMBODIMENTS

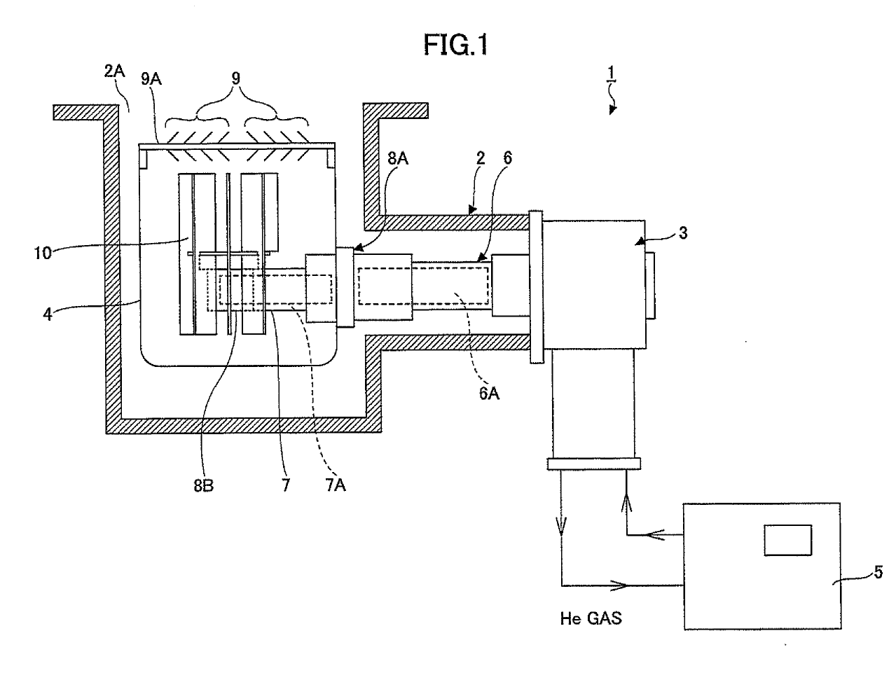

A description is given below, with reference to FIG. 1 through FIG. 12 of embodiments of the present invention.

FIG. 1 is a structural view of a cryopump where a cryopanel of an embodiment of the present invention is used. A cryopump 1 includes a vacuum chamber 2, a cryocooler 3, a shield 4, and a cryopanel 10.

The vacuum chamber 2 is connected to a process chamber (not shown in FIG. 1) of a semiconductor manufacturing apparatus such as a sputtering apparatus or an ion implantation apparatus, via an upper part opening 2A. Cylinders 6 and 7 of the cryocooler 3, the shield 4, and the cryopanel 10 are provided inside the vacuum chamber 2.

A pump for roughing (not shown in FIG. 1) and a pipe for introducing purge gas (not shown in FIG. 1) are connected to the vacuum chamber 2. A gate valve (not shown in FIG. 1) is provided between the vacuum chamber 2 and the process chamber.

A compressor 5 is connected to the cryocooler 3. The compressor 5 is configured to increase the pressure of coolant gas such as helium gas so as to transfer the coolant gas to the cryocooler 3. The compressor 5 is also configured to receive the coolant gas which is adiabatically expanded by the cryocooler 3 so as to increase the pressure of the coolant gas again.

The cryocooler 3 is, for example, a two-stage type GM (Gifford-McMahon) cryocooler. The cryocooler 3 includes the first stage cylinder 6, a second stage cylinder 7, and a motor (not shown In FIG. 1). A first stage displacer 6A is installed in the first stage cylinder 6. A second stage displacer 7A is installed in the second stage cylinder 7. The first stage displacer 6A and the second stage displacer 7A are connected to each other.

A cryogenic state based on adiabatic expansion is generated by reciprocally moving the first stage displacer 6A and the second stage displacer 7A in right and left directions by the motor.

A first cryocooling stage 8A is brazed on the external circumference of the first stage cylinder 6. The shield 4 is held by the first cryocooling stage 8A.

The shield 4 is a cap-shaped member made of copper or aluminum. The shield 4 is configured to protect the cryopanel 10 from radiation heat of the vacuum chamber 2. A nickel plating process is applied to an external surface of the shield 4. A black chrome plating process is applied to an internal surface of the shield 4. This is because the nickel plating process is proper for reflecting the radiation heat from the vacuum chamber on the external surface of the shield 4. On the other hand, it is necessary to absorb heat inside the shield 4 in order to prevent the heat transferring to the cryopanel 10.

Louvers 9 are provided at an upper part opening of the shield 9. The louvers 9 are formed by arranging circular ring-shaped louver pieces made of copper, in concentric circles. A nickel plating process is applied to the surfaces of the louvers 9. The louvers 9 are provided so as to close the upper part opening 2A of the vacuum chamber 2. The louver 9 is supported by a stay 9A connecting the sides of the shield 4 to each other.

The shield 4 and the louvers 9 are cooled by the first cryocooling stage 8A at approximately 30 K through approximately 100 K.

In addition, the second cryocooling stage 8B is brazed on the external circumference of the second stage cylinder 7. The cryopanel 10 is held and cooled at approximately 4 K through approximately 20 K by the second cryocooling stage 8B.

The following explanation is based on the assumption that hydro-molecules, argon, nitrogen, hydrogen, neon, and helium exist in the process chamber.

When the shield 4 and the louvers 9 are cooled at approximately 30 K through approximately 100 K and the cryopanel 10 is at approximately 4 K through approximately 20 K, the hydro-molecules are solidified by the shield 4 and the louvers 9 and argon and nitrogen other than the hydro-molecules are mainly solidified by the cryopanel 10. Furthermore, hydrogen, neon, helium and others are mainly absorbed by active carbon layers formed on the surface of the cryopanel 10. As a result of this, the process chamber is discharged so as to be maintained in a high vacuum state.

Gas in the process chamber flows into the vacuum chamber 2 via the upper part opening 2A. In the following explanations, a ‘gas flow-in’ means gas flowing downward from the upper part opening 2A of the vacuum chamber.

The louvers 9 are provided above the cryopanel 10 and a bottom part of the shield 4 is situated below the cryopanel 10.

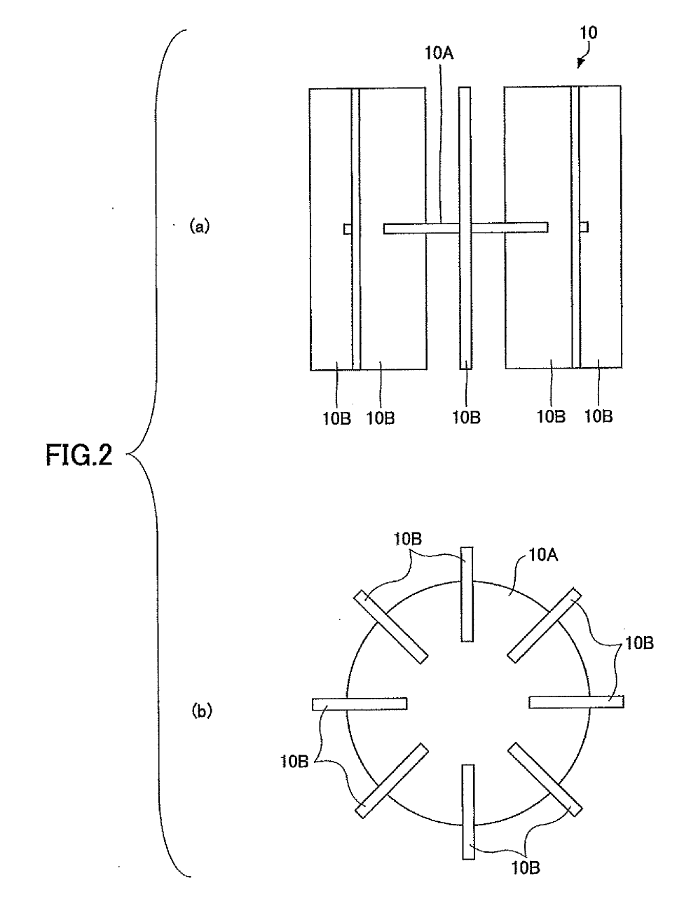

FIG. 2 is a view showing a structure of the cryopanel 10 of the embodiment of the present invention (FIG. 2(a) is a front view and FIG. 2(b) is a plan view).

Referring to FIG. 2(a) and FIG. 2(b), the cryopanel 10 includes a disk-shaped panel 10A and eight plate-shaped panels 10B. The disk-shaped panel 10A is held by the first cryocooling stage 8A. The plate-shaped panels 10B are provided at the external circumferential part of the disk-shaped panel 10 with equal angular gaps. Each plate-shaped panel 10B is provided so as to extend from the disk-shaped panel 10A to upstream and downstream in the gas flow-in and extend outside of the external circumference of the disk-shaped panel 10A.

The plate-shaped panels 10B are separated from each other in the center part in the diameter direction of the disk-shaped panel 10A. In addition, the length in the upstream direction of the plate-shaped panels 10B is the same as the length in the downstream direction of the plate-shaped panels 10B.

The disk-shaped panel 10A and the eight disk-shaped panels 10B are made of copper and plating is applied to the disk-shaped panel 10A and the disk-shaped panels 10B. In addition, active layers (not shown in FIG. 2) configured to absorb hydrogen, neon, helium and others are adhered on both surfaces of each plate-shaped panel 10B. The disk-shaped panel 10A and the disk-shaped panels 10B may be connected to each other by soldering or screws or may be formed in a body.

Thus, in the cryopanel 10 of the embodiment of the present invention, each plate-shaped panel 10B is provided so as to extend from the disk-shaped panel 10A to upstream and downstream directions in the gas flow-in and extend outside of the external circumference of the disk-shaped panel 10A. Accordingly, compared to a cryopanel where the plate-shaped panel is provided at only the downstream side of the disk-shaped panel, the cryopanel of the embodiment of the present invention can secure a sufficient surface area.

According to this structure, it is possible to improve the discharge velocity. In particular, since the surface area of the plate-shaped panel 10B where the active layer is formed increases, it is possible to improve the absorption rate of hydrogen, neon, helium and the like which is not solidified even if cooling is applied.

In addition, the plate-shaped panel 10B where the active layer is formed exists at the upstream side of the disk-shaped panel 10A. Therefore, it is possible to improve the solidifying or absorption efficiency which may be low at a downstream side of the disk-shaped panel 10A.

In a case where the length in the upstream direction of the plate-shaped panel 10B is the same as the length in the downstream direction of the plate-shaped panel 10B, when the plate-shaped panel 10B is cooled by the second cryocooling stage 8B shown in FIG. 1, a temperature distribution in the upstream direction and the downstream direction can be controlled. Hence, it is possible to equally absorb hydrogen, neon, helium, and others which cannot be solidified.

In addition, since the plate-shaped panel 10B extend in the diameter direction outside of the external circumference of the disk-shaped panel 10A, it is possible to secure a sufficient flow path along the gas flow-in. Because of this, it is possible to provide the cryopanel 10 whereby discharge velocity can be improved.

Furthermore, since the plate-shaped panels 10B are separated from each other at the center part in the diameter direction of the disk-shaped panel 10A, it is possible to secure a sufficient flow path at the center part of each plate-shaped panel 10B.

In addition, active layers having different absorption rates may be formed on the plate-shaped panels 10B at upstream and downstream sides of the disk-shaped panel 10A. The rate of hydrogen, neon, helium and others absorbed by the active layer at the upstream side is higher than those at the downstream side. Therefore, by setting the rate of absorption of the active layers of the upstream side higher than those of the downstream side, it is possible to absorb hydrogen more efficiently.

The plate-shaped panels 10B are also cooled at approximately 4 K through approximately 20K. Therefore, by extending the plate-shaped panels 10B to the upstream side and the downstream side of the disk-shaped panel 10A so that the surface area is expanded, the solidifying rate of argon and nitrogen in addition to hydrogen, neon, helium, and others is improved.

Because of this, even if the diameter of the disk-shaped panel 10A is made slightly smaller, it is possible to maintain the solidifying rate of argon and nitrogen high, compared to the conventional cryopanel. Thus, in a case where the diameter of the disk-shaped panel 10A can be downsized, it is possible to improve the flow-in efficiency of gas from the upstream side to the downstream side.

A so-called horizontal type cryopump where the first cooling stage 8A and the second cooling stage 8B of the cryocooler 3 are inserted in a horizontal direction of the vacuum chamber 2 is shown in FIG. 1.

In such a horizontal type cryopump, it may be necessary that some of the plural plate-shaped panels 10B extend to only the upstream side so as to avoid the second cooling stage 8B. In this case, the length of the plate-shaped panel 10B of the cryopanel of the embodiment of the present invention may be appropriately changed.

The cryopanel 10 of the embodiment of the present invention can be applied to a so-called vertical type cryopump where the stage of the cryocooler 3 is inserted in an upper or lower direction relative to the vacuum chamber.

### FIRST MODIFIED EXAMPLE

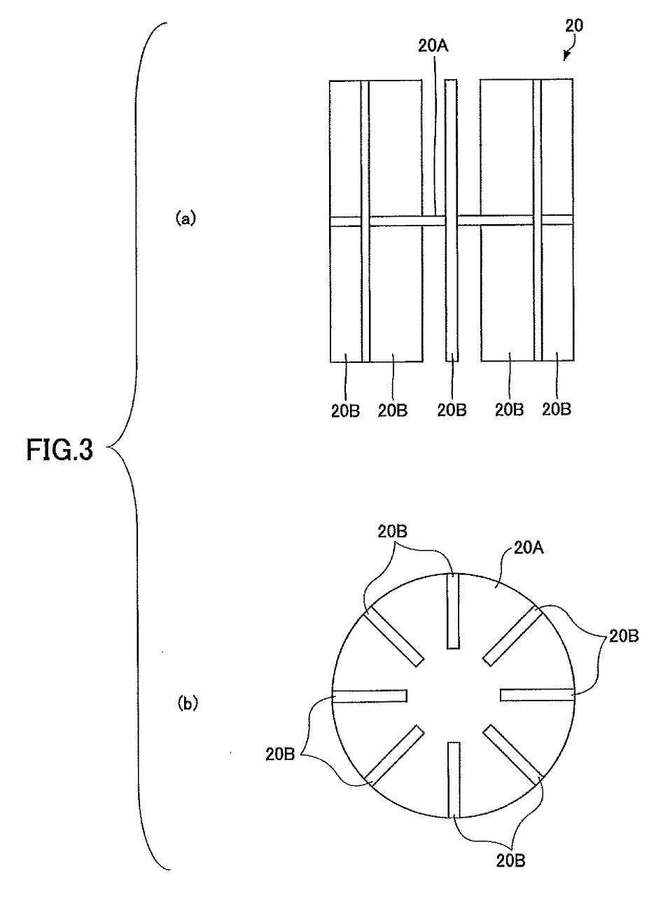

FIG. 3 is a view of a cryopanel of a first modified example of the embodiment of the present invention (FIG. 3(a) is a front view and FIG. 3(b) is a plan view).

In a cryopanel 20, unlike the cryopanel 10 shown in FIG. 2, end parts in diameter directions of plate-shaped panels 20B are situated in the same position as (diameter direction positions of) the external circumference of the disk-shaped panel 20A. The diameter of the disk-shaped panel 20A is the same as that of the disk-shaped panel 10A shown in FIG. 2. The plate-shaped panels 20B have the same lengths from the disk-shaped panel 20A to the upstream side and the downstream side of the gas flow-in.

According to the above-mentioned cryopanel 20, it is possible to improve the discharge velocity. In particular, since the surface area of the plate-shaped panels 203 where the active layers are formed is increased, it is possible to improve the absorption rate of hydrogen, neon, helium, and the like. Hydrogen, neon, helium, or the like is not solidified even if cooled.

In addition, the plate-shaped panels 20B where the active layers are formed are provided at the upstream side of the plate-shaped panel 20A. Hence, compared to a case where the plate-shaped panels 10B are provided at the downstream side of the disk-shaped panel 10A, it is possible to improve the solidifying and absorption efficiencies.

### SECOND MODIFIED EXAMPLE

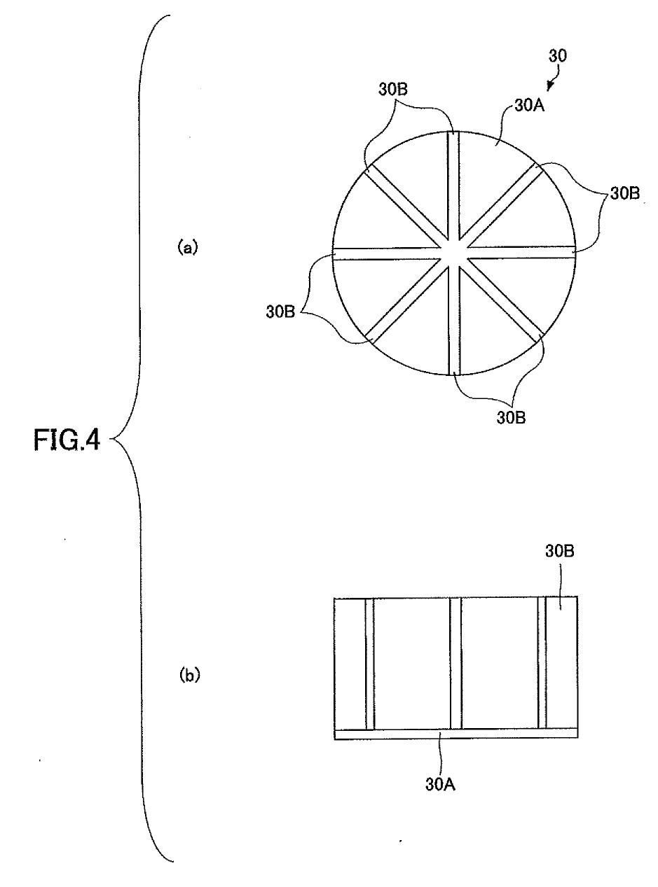

FIG. 4 is a view of a cryopanel of a second modified example of the embodiment of the present invention (FIG. 4(a) is a plan view and FIG. 4(b) is a front view).

In a cryopanel 30, unlike the cryopanel 10 shown in FIG. 2, end parts in diameter directions of the plate-shape panels 30B are situated in the same position as (diameter direction positions of) the external circumference of the disk-shaped panel 30A. In addition, the plate-shaped panels 30B are connected to each other at the center in a diameter direction of the disk-shaped panel 30A.

Furthermore, the diameter of the disk-shaped panel 30A is the same as that of the disk-shaped panel 10A shown in FIG. 2. The plate-shaped panels 30B extend from the disk-shaped panel 30A in only the upstream direction of the gas flow-in.

According to the above-mentioned cryopanel 30, the plate-shaped panels 30B where the active layers are formed are provided at the upstream side of the disk-shaped panel 30A. Hence, compared to a case where the plate-shaped panels are provided at the downstream side of the disk-shaped panel, it is possible to improve the solidifying and absorption efficiencies.

While the plate-shaped panels 30B are provided at only the upstream side of the disk-shaped panel 30A, the plate-shaped panels 30B are connected to each other at the center in a diameter direction of the disk-shaped panel 30A. Accordingly, the surface areas where the active layers are formed are increased so that it is possible to improve the solidifying and absorption efficiency rates.

### THIRD MODIFIED EXAMPLE

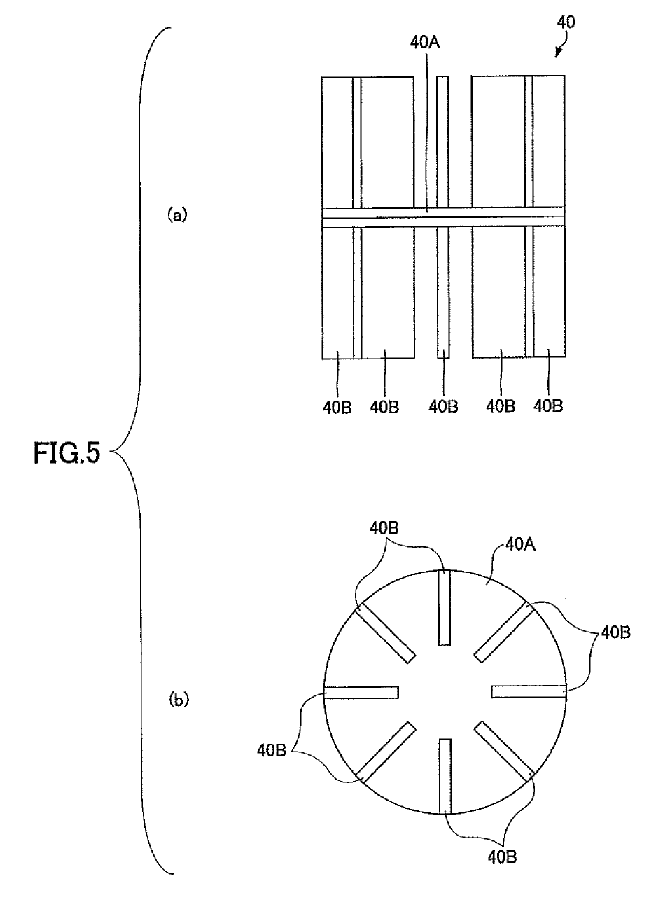

FIG. 5 is a view of a cryopanel of a third modified example of the embodiment of the present invention (FIG. 5(a) is a front view and FIG. 5(b) is a plan view).

Plate-shaped panels 40B of the cryopanel 40, unlike the plate-shaped panels 30B of the cryopanel 30, are not provided in the vicinity of the center in the diameter direction of a disk-shaped panel 40A. The cryopanel 40 is formed by connecting two disk-shaped panels 40A. Eight plate-shaped panels 40B are formed on one surface of each disk-shaped panel 40A.

By this connection of two disk-shaped panels 40A, it is possible to obtain the cryopanel 40 having the same configuration as the cryopanel 20 shown in FIG. 3.

According to the above-mentioned cryopanel 40, it is possible to improve the discharge velocity. In particular, since the surface area of the plate-shaped panel 40B where the active layer is formed is increased, it is possible to improve the absorption rate of hydrogen, neon, helium, and the like. Hydrogen, neon, helium, or the like is not solidified even if cooled.

In addition, the plate-shaped panels 40B where the active layers are formed are provided at the upstream side of the disk-shaped panel 40A. Hence, compared to a case where the plate-shaped panel 10B is provided at the downstream side of the disk-shaped panel 10A, it is possible to improve the solidifying and absorption efficiencies.

Since the cryopanel 40 has a configuration similar with a configuration of a structure where two cryopanels 30 shown in FIG. 4 are connected to each other, it is possible to easily form the cryopanel 40.

### FOURTH MODIFIED EXAMPLE

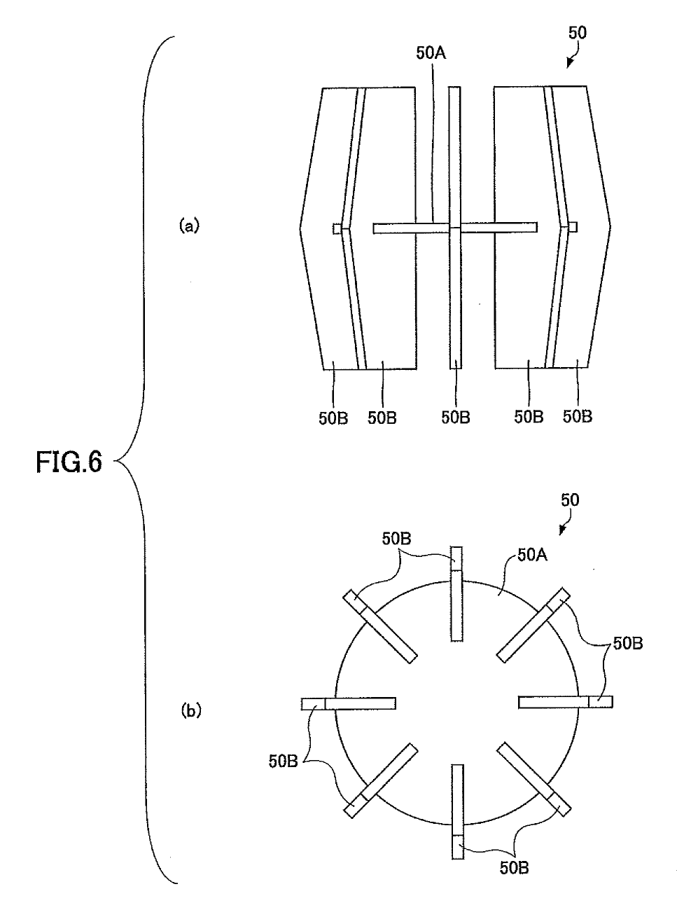

FIG. 6 is a view of a cryopanel of a fourth modified example of the embodiment of the present invention (FIG. 6(a) is a front view and FIG. 6(b) is a plan view).

In a cryopanel 50 unlike the cryopanel 10 shown in FIG. 2, a plate-shaped panel 50B has a configuration in a gas flow-in direction where the width of the disk-shaped panel 50A is narrower as a position is near the head ends at upstream and downstream of the disk-shaped panel 50A. Others are the same as the cryopanel 10 shown in FIG. 2.

In the above-mentioned cryopanel 50, it is possible to improve the discharge velocity, and especially the absorption rate of hydrogen, neon, helium, and the like. As a position is farther from a part supported by the disk-shaped panel 50A, the width of the plate-shaped panel 50B is narrower. Hence, it is possible to further improve the temperature distribution of the plate-shaped panels 50B from the upstream side to the downstream side.

### FIFTH MODIFIED EXAMPLE

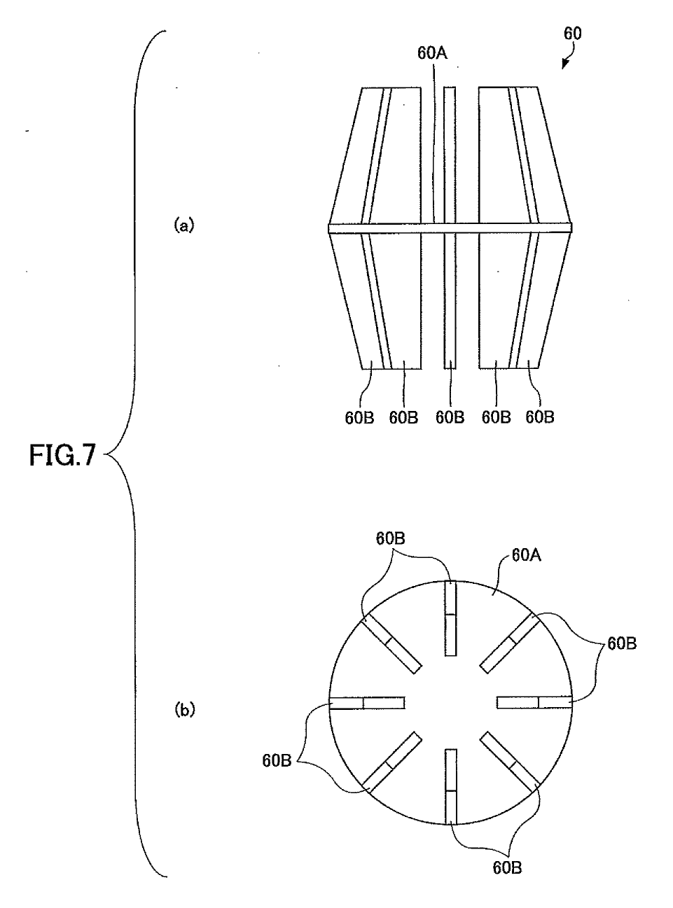

FIG. 7 is a view of a cryopanel of a fifth modified example of the embodiment of the present invention (FIG. 7(a) is a front view and FIG. 7(b) is a plan view).

In a cryopanel 60 unlike the cryopanel 20 shown in FIG. 2, a plate-shaped panel 60B has a configuration in a gas flow-in where the width of the plate-shaped panel 60B is narrower as a position is nearer the head ends upstream and downstream of the disk-shaped panel 60A. Others are the same as the cryopanel 20 shown in FIG. 2.

In the above-mentioned cryopanel 60, it is possible to improve the discharge velocity, and especially the absorption rate of hydrogen, neon, helium, and the like. As a position is farther from the disk-shaped panel 60A, the width of the plate-shaped panel 60B is narrower. Hence, it is possible to further improve the temperature distribution of the plate-shaped panels 60B from the upstream side to the downstream side.

### SIXTH MODIFIED EXAMPLE

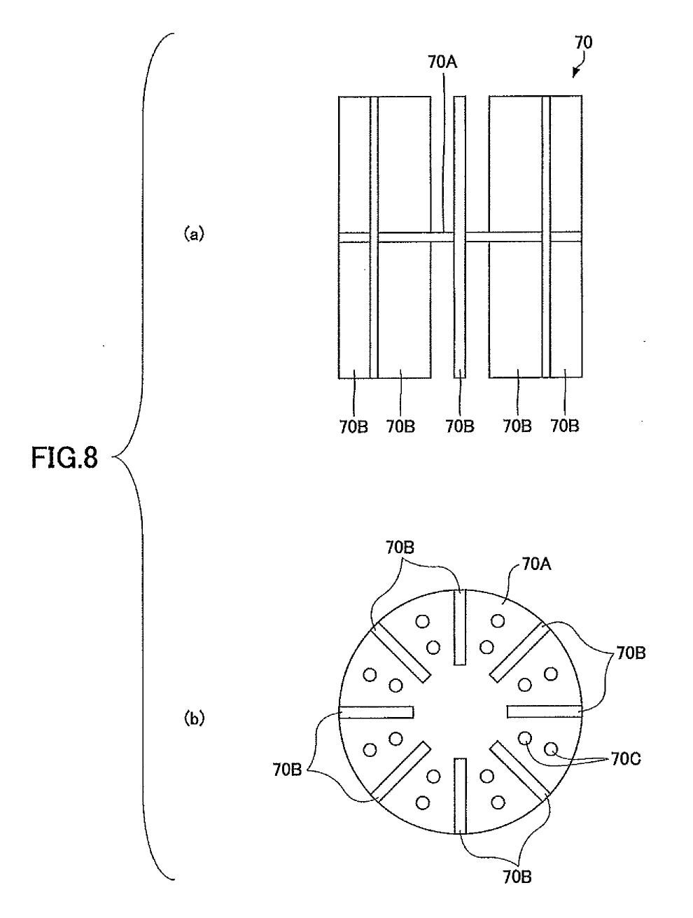

FIG. 8 is a view of a cryopanel of a sixth modified example of the embodiment of the present invention (FIG. 8(a) if a front view and FIG. 8(b) is a plan view).

In a cryopanel 70, unlike the cryopanel 20 shown in FIG. 3, a disk-shaped panel 70A has hole forming parts 70C. The hole forming parts 70C pierce the disk-shaped panel 70 in a thickness direction. Others are the same as the cryopanel 20 shown in FIG. 3.

In the above-mentioned cryopanel 70, as well as the cryopanel 20 shown in FIG. 3, it is possible to improve the discharge velocity, and especially the absorption rate of hydrogen, neon, helium, or the like. In addition, it is possible to secure a sufficient flow path in a gas flow-in due to the hole forming parts 70C formed in the disk-shaped panel 70A.

Furthermore, by the hole forming parts 70C, compared to a case where the plate-shaped panel are provided at the downstream side of the disk-shaped panel, it is possible to improve the solidifying and absorption efficiencies.

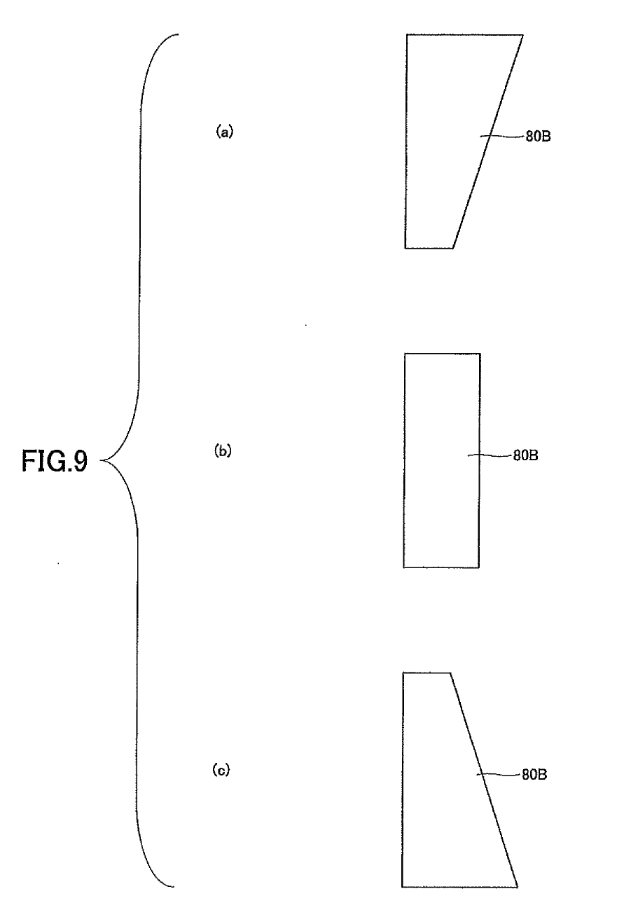

FIG. 9 is a front view of a modified example of a plate-shaped panel included in the cryopanel of the embodiment of the present invention.

The cryopanel of this example may have any of a reverse trapezoidal-shaped configuration shown in FIG. 9(a), a rectangular-shaped configuration shown in FIG. 9(b), and a trapezoidal-shaped configuration shown in FIG. 9(c). For example, a plate-shaped panel 80B having the reverse trapezoidal-shaped configuration shown in FIG. 9(a) may be provided at the upstream side of the disk-shaped panel 80A and a plate-shaped panel 80B having the trapezoidal-shaped configuration shown in FIG. 9(a) may be provided at the downstream side of the disk-shaped panel 80A.

### SEVENTH MODIFIED EXAMPLE

Next, A cryopump using the cryopanel 20 of the first modified example is discussed as a seventh modified example.

In the cryopump of the seventh modified example using the cryopanel 20 of the first modified example, a blackening process is applied to rear side surfaces of louvers 9, namely down stream side surfaces in the gas flow-in.

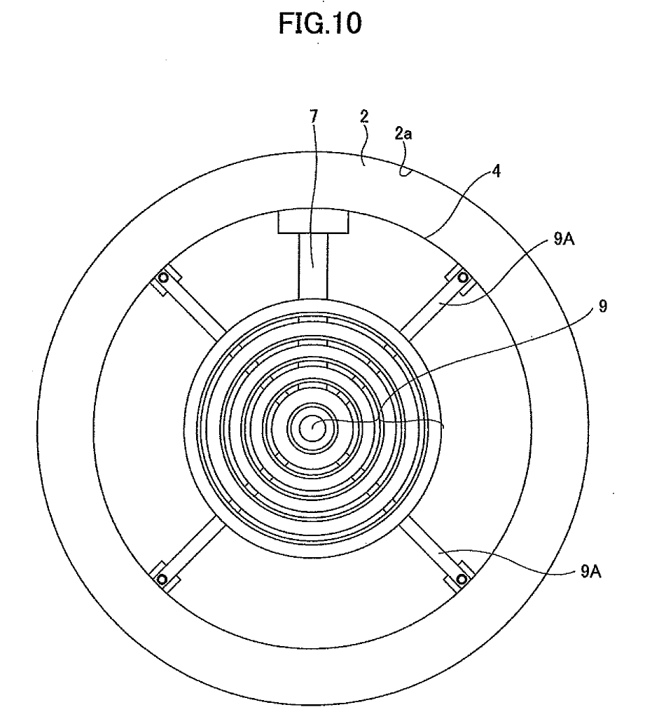

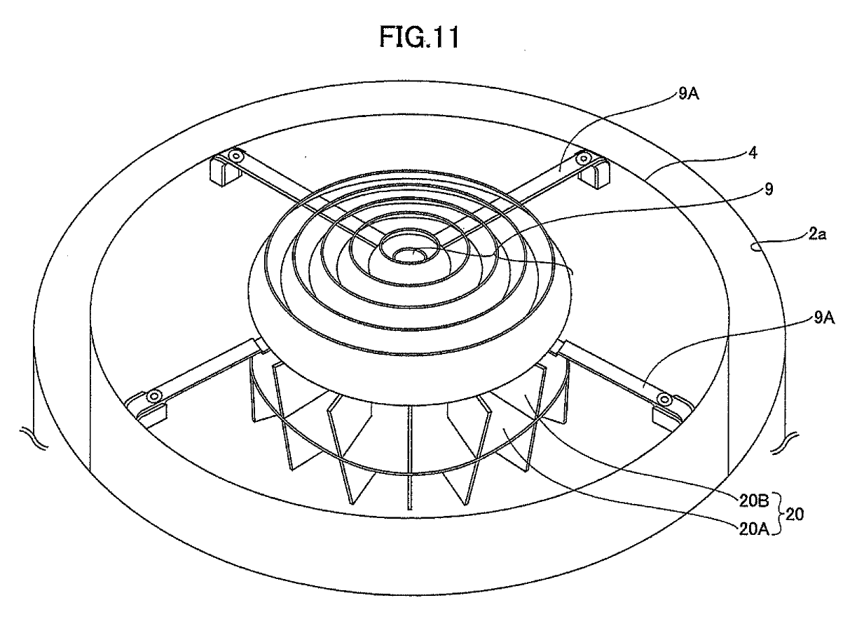

FIG. 10 is a plan view of a cryopump of a seventh modified example of the embodiment of the present invention. FIG. 11 is a perspective view of the cryopump of the seventh modified example of the embodiment of the present invention.

As shown in FIG. 10 and FIG. 11, a shield 4 is provided in a concentric manner with a certain width from an internal surface 2a of a vacuum chamber 2.

The louvers 9 are mounted on stays 9A fixed to an internal surface 4a of the shield 4 by screws. Two stays 9A are provided so as to cross each other. While the louvers 9 are provided at the lower side (downstream side) of the stays 9A in FIG. 1, the louvers 9 are provided at the upper side (upstream side) of the stays 9A in FIG. 11.

In the louvers 9, a nickel plating process is applied to a surface of the upstream side in the gas flow-in. A coating process is applied to a rear surface of the louvers 9 by a black color spray of fluoride resin group member whose main ingredient is ultrafine particle graphite.

It is preferable that, in the stays 9A as well as the louvers 9, nickel plating processes are applied to surfaces of the upstream sides in the gas flow-in. Coating processes are applied to rear surfaces of the stays 9A by black color sprays of the fluoride resin group member whose main ingredient is ultrafine particle graphite.

As discussed above, a nickel plating process is applied to an outside surface of the shield 4 and a black color chrome plating process is applied to an inside surface of the shield 4.

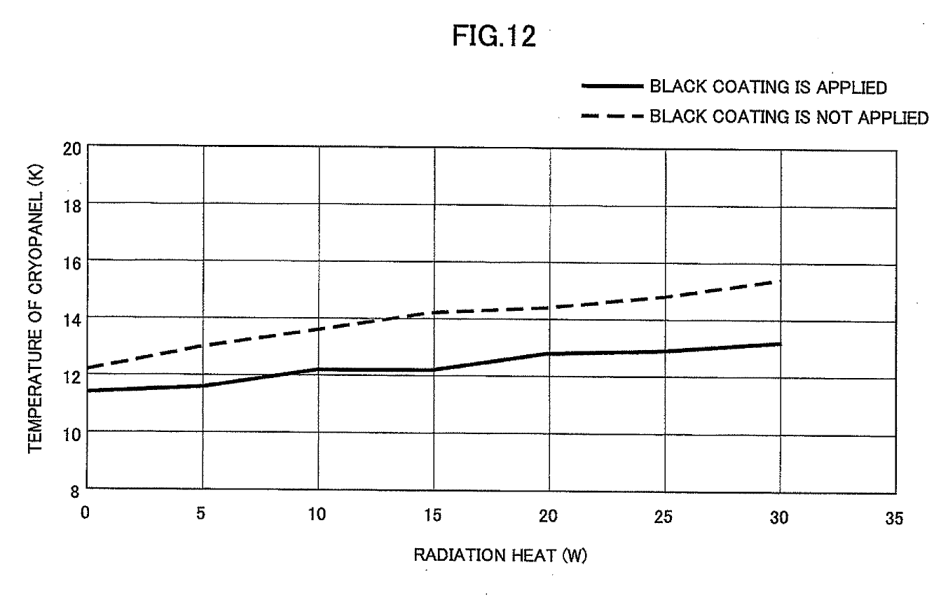

FIG. 12 is a graph showing cooling properties of the cryopump of the seventh modified example of the embodiment of the present invention.

The horizontal axis of the table shown in FIG. 12 indicates radiation heat (W) and the vertical axis indicates temperature (K) of the cryopanel 20. A cryopump where a blackening coating is applied to the rear surface sides of the louvers 9 and a cryopump where the blackening coating is not applied to the rear surface sides are compared in this graph.

A heater was provided above the louvers 9 and the output of the heater was measured as the energy of the radiation heat so that these properties were obtained.

As shown in FIG. 12, the temperature of the cryopanel 20 of the cryopump where the black coating is not applied to the rear side of the louver 9 was approximately 12 K when the radiation heat is 0 W. The temperature was increased as the energy of the radiation heat was increased so that temperature was higher than 14 K when the radiation heat is approximately 13 W. When the radiation heat became 30 W, the temperature became approximately 15 K.

On the other hand, the temperature of the cryopanel 20 of the cryopump where the black coating is applied to the rear side of the louver 9 was approximately 11.5 K when the radiation heat was 0 W. When the radiation heat was 8 W, the temperature became 12 K. Even though the radiation heat became 30 W, the temperature was just higher than approximately 13K. Thus, an increase of the temperature in the cryopanel 20 of the cryopump where the black coating is applied to the rear side of the louvers 9 is prevented, compared to the cryopanel 20 of the cryopump where the black coating is not applied to the rear side of the louvers 9.

The reasons why the cooling properties of the cryopanel 20 are improved are as follows.

In the louvers 9, the cryopanel 20 in the vacuum chamber 2 is required to be protected from the radiation heat. In addition, gas is required to be led to the cryopanel 20. While the louvers 9 cover the cryopanel 20 as shown in FIG. 10 seen in a plan view, the louvers 9 do not completely cover the cryopanel 20 as shown in FIG. 11 obliquely seen from an upper part. Because of this, it is not possible to completely shield the transfer of the radiation heat to the cryopanel 20.

However, in a case where the black color coating is applied to the rear surface of the louvers 9, the radiation heat passing through the louvers 9 is absorbed by a black color coated part of the rear surface of the louvers 9. Because of this, the radiation heat transferred to the cryopanel 20 is reduced, so that the cooling properties of the cryopanel 20 are improved.

Thus, according to the cryopump of the seventh modified embodiment of the present invention, the temperature of the cryopanel can be made equal to or lower than 14 K. Hence, it is possible to improve the absorption rate of hydrogen, neon, helium, or the like. Hydrogen, neon, helium, and the like is not solidified even if cooled. Especially, in a region where the radiation heat is low and equal to or less than approximately 8 W, the cryopanel 20 can be cooled so that the temperature of the cryopanel 20 can be equal to or less than 12 K. Hence, it is possible to obtain very high absorption properties.

As discussed above, according to the cryopump of the seventh embodiment of the present invention, the cryopanel includes the plate-shaped panels 20B extending upstream and downstream from the disk-shaped panel 20A in the gas flow-in. Hence, compared to the cryopanel having the plate-shaped panels provided at only the downstream side of the disk-shaped panel, it is possible to secure sufficient surface areas in the cryopanel 20.

In addition, by applying the blackening process to the rear surface of the louvers 9, it is possible to further develop the discharging velocity. As a result of this, the cooling temperature of the cryopanel 20 can be further decreased. Hence, it is possible to provide the cryopump where the amount of absorption is further improved.

In the above explanation, a coating process using a black spray of a fluoride resin group member whose main ingredient is fine particle graphite is discussed as a blackening process applied to the louvers 9 (and the stays 9A). However, in the present invention, a coating material other than fluoride resin may be applied and black color chrome plating may be applied.

Furthermore, as shown in FIG. 1, in a case where the louvers 9 are provided at the lower side (downstream side) of the stay 9A, too, a nickel plating process may be applied to the upper side (upstream side) surface of the louvers 9 provided below the stay 9A and a black color chrome plating process may be applied to the lower side (downstream side).

Furthermore, in the above-discuss explanation, an example where the black color chrome plating process is applied to the inside surface of the shield 4 is discussed. However, in the present invention, a black coating process may be applied to the inside surface of the shield 4 as well as the rear surface of the louvers 9.

According to the above-discussed embodiments, it is possible to provide a cryopanel used for a cryopump, the cryopump including a vacuum chamber having a gas flow-in opening; a stage provided in the vacuum chamber; and a cryocooler configured to cool the stage, the cryopump being configured to solidify or absorb a molecule flowing from the gas flow-in opening into the vacuum chamber, the cryopanel including: a first panel held and cooled by the stage, the first panel having a surface facing toward the gas flow-in opening; and a second panel held by the first panel and extending from the first panel in an upstream direction of a gas flow-in, the second panel having a surface where an absorption material layer is formed.

The first panel may include a disk-shaped panel; and the second panel may be formed by a plurality of plate-shaped members, the plate-shaped members having surfaces provided in a radial manner separated by equal angular gaps in the external circumferential direction of the first panel.

An external edge of the second panel may be situated outside the external edge of the first panel in a diameter direction of the first panel.

The plate-shaped members of the second panel may be separated from each other at a center part in a diameter direction of the first panel.

The plate-shaped members of the second panel may be separated from each other at a center part in the diameter direction of the first panel.

The second panel may extend from the first panel in a downstream direction of the gas flow-in in addition to the upstream direction.

The width of the second panel may be narrower as the second panel is separated from a supporting part supported by the first panel.

The first panel may include a hole forming part configured to pierce the first panel in a thickness direction.

The cryopump may be used for ion implantation.

According to the above-discussed embodiments, it is also possible to provide a cryopump, including: a vacuum chamber having a gas flow-in opening; a cryocooler having a stage provided in the vacuum chamber, the cryocooler being configured to cool the stage; a cryopanel; a shield having an opening part connected to the cryocooler so that the opening part faces the gas flow-in opening of the vacuum chamber, the shield having an inside where the cryopanel is received, the shield being configured to protect the cryopanel from radiation heat of the vacuum chamber; and a louver covering the opening of the shield; wherein a molecule flowing from the gas flow-in opening to the vacuum chamber is solidified or absorbed by the cryopump; the cryopanel includes a first panel held and cooled by the stage, the first panel having a surface facing toward the gas flow-in opening, and a second panel held by the first panel and extending from the first panel in an upstream direction of a gas flow-in, the second panel having a surface where an absorption material layer is formed; and blackening is applied to a surface of the louver which surfaces is in a downstream direction of the gas flow-in.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

This patent application is based on Japanese Priority Patent Application No. 2007-206907 filed on Aug. 8, 2007 and Japanese Priority Patent Application No. 2008-29048 filed on Feb. 8, 2008, and the entire contents of which are hereby incorporated herein by references.

What is claimed is:

1. A cryopanel used for a cryopump,
the cryopump including
a vacuum chamber having a gas flow-in opening;
a stage provided in the vacuum chamber; and
a cryocooler configured to cool the stage,
the cryopump being configured to solidify or absorb a molecule flowing from the gas flow-in opening into the vacuum chamber,
the cryopanel comprising:
a first panel held and cooled by the stage, the first panel having a surface facing toward the gas flow-in opening; and
a second panel held by the first panel and extending from the first panel in an upstream direction of a gas flow-in, the second panel having a surface where an absorption material layer is formed.

2. The cryopanel as claimed in claim 1,
wherein the first panel includes a disk-shaped panel; and
the second panel is formed by a plurality of plate-shaped members, the plate-shaped members having surfaces provided in a radial manner separated by equal angular gaps in the external circumferential direction of the first panel.

3. The cryopanel as claimed in claim 1,
wherein an external edge of the second panel is situated outside the external edge of the first panel in a diameter direction of the first panel.

4. The cryopanel as claimed in claim 2,
wherein the plate-shaped members of the second panel are separated from each other at a center part in a diameter direction of the first panel.

5. The cryopanel as claimed in claim 3,
wherein the plate-shaped members of the second panel are separated from each other at a center part in the diameter direction of the first panel.

6. The cryopanel as claimed in claim 1,
wherein the second panel extends from the first panel in a downstream direction of the gas flow-in in addition to the upstream direction.

7. The cryopanel as claimed in claim 1,
wherein the width of the second panel is narrower as the second panel is separated from a supporting part supported by the first panel.

8. The cryopanel as claimed in claim 1,
wherein the first panel includes a hole forming part configured to pierce the first panel in a thickness direction.

9. The cryopanel as claimed in claim 1,
wherein the cryopump is used for ion implantation.

10. A cryopump, comprising:
a vacuum chamber having a gas flow-in opening;
a cryocooler having a stage provided in the vacuum chamber, the cryocooler being configured to cool the stage;
a cryopanel;
a shield having an opening part connected to the cryocooler so that the opening part faces the gas flow-in opening of the vacuum chamber, the shield having an inside where the cryopanel is received, the shield being configured to protect the cryopanel from radiation heat of the vacuum chamber; and
a louver covering the opening of the shield;
wherein a molecule flowing from the gas flow-in opening to the vacuum chamber is solidified or absorbed by the cryopump;
the cryopanel includes
a first panel held and cooled by the stage, the first panel having a surface facing toward the gas flow-in opening, and
a second panel held by the first panel and extending from the first panel in an upstream direction of a gas flow-in, the second panel having a surface where an absorption material layer is formed; and
blackening is applied to a surface of the louver which surfaces is in a downstream direction of the gas flow-in.
